(19) United States
(12) Patent Application Publication
(10) Pub. No.: US 2025/0340399 A1
(43) Pub. Date: Nov. 6, 2025

(54) HOSE REEL ASSEMBLY WITH LOCKING WINDING SPOOL

(71) Applicant: POWERPLAY CORPORATION, Dorval (CA)

(72) Inventor: Shawn Kahan, Dorval (CA)

(21) Appl. No.: 19/188,189

(22) Filed: Apr. 24, 2025

(30) Foreign Application Priority Data
May 1, 2024 (CA) 3237401

(51) Int. Cl. B65H 75/40; B05B 9/01; B65H 75/42; B65H 75/44

(52) U.S. Cl. CPC B65H 75/403; B65H 75/42; B65H 75/4428; B65H 75/4471; B65H 75/4492; B05B 9/01

(57) ABSTRACT

A hose reel assembly for use in the storage and deployment of pressure washer or air compressor hoses includes a winding spool having a winding shaft about which a length of hose may be coiled or uncoiled. The winding spool is rotatably supported on support frame which internally positions the winding shaft substantially within the pressure or air compressor housing.

### SCOPE OF THE INVENTION

The present invention relates to a hose reel assembly for the storage and deployment of flexible hoses, and more preferably a hose reel assembly which incorporates a locking winding spool which is suitable for the storage and deployment of hoses used with high pressure spray washers, pneumatic tool compressors and the like.

### BACKGROUND OF THE INVENTION

The use of hose reels in the storage and deployment of rubber and PVC air and/or water hoses is well known. Conventional hose reels incorporate a winding spool having a cylindrical spool shaft, and which rotatably mount on a frame or wall mounted support arm. The winding spool is typically adapted to be freely journaled in rotation to allow a length of flexible hose to be coiled or uncoiled above the spool shaft as the hose is stored or deployed.

Conventional hose reel constructions have proven poorly suited for use with portable high pressure spray washers and air compressors used with pneumatic tools. In particular, when using portable power tools and equipment, users frequently use the unit hose to move or reposition the pressure washer or air compressor during use, as for example, when one moves about a vehicle. With commercial pressure washers, hoses are therefore typically stored in a loosely coiled arrangement suspended on a washer frame hook, with the user carrying coiled lengths of hose when moving the washer between locations.

### SUMMARY OF THE INVENTION

One non-limiting object of the invention is to provide a hose reel assembly for coiled storage and uncoiled deployment of elongated flexible hoses, and which is suitable for use with portable high pressure washers, air compressors, water pumps and the like.

Another non-limiting object of the invention is to provide a hose reel assembly for the storage and deployment of flexible hoses, and which includes a rotatable winding spool having a winding spool shaft about which a length of hose may be coiled. Preferably, the spool shaft may be selectively locked in place, with the hose in a fully stored, partially deployed, and/or fully deployed configuration. M ore preferably, the winding spool is used with a portable power tool such as a pressure spray washer or air compressor, and is adapted to be selectively locked against rotation with a length of hose partially deployed, and whereby the application of a manual tension on the hose may be used to reposition the power tool.

In another non-limiting embodiment, a hose reel assembly is provided for use as part of a portable high pressure washer or air compressor, and which includes a tensioning mechanism for maintaining a desired preselected winding and/or rotary tension on the winding spool shaft as the flexible hose is coiled and/or uncoiled in storage or deployment.

In a further non-limiting embodiment of the invention, a hose reel assembly is provided for use in a high pressure spray washer which is mostly formed from non-corrosive components, and preferably components made of plastics, such as ABS, PVC, or Nylon™.

A further embodiment of the invention provides a hose reel assembly for the storage and deployment of pressure washer water hoses, and which has a sufficiently compact design to allow for hose storage internally within a portable pressure washer housing.

In another non-limiting embodiment, the present invention provides for a hose reel assembly which for example may be used in the storage and deployment of flexible water or air hoses used with a portable pressure washer or air compressor. The hose reel assembly includes a winding spool having a spool or winding shaft about which a length of hose may be coiled or uncoiled in storage and deployment. The winding spool is rotatably supported on a suitable frame or support and is adapted to be journaled in rotation about a shaft axis in the storage and deployment. Although not essential, most preferably, the support frame is provided as U-frame or cradle which internally positions the winding shaft substantially within the pressure washer or air compressor housing. M ost preferably, the winding spool is sized so as to allow a majority, and preferably almost the entirety of the hose length to be coiled thereabout in a stored position within the unit housing itself. Although not essential, most preferably, the support frame is configured to maintain the winding spool axis in a generally horizontal orientation as the hose is wound and/or unwound about the winding spool in use of the pressure washer or air compressor.

A clutch or ratcheting assembly is provided to effect the unidirectional winding spool rotation and the coiling of the hose about the spool shaft. In a preferred construction, the clutch or ratcheting assembly includes a drum wheel and a ratchet member. The drum wheel is fixedly secured to the winding spool for rotation therewith about the winding spool axis. The ratchet member is configured for engaging contact with portions of the drum wheel to effect its rotational movement in a single direction only.

In one non-limiting construction, the ratchet member may be provided with one or more resiliently positionable fingers or arms. When the ratchet member is rotated in a first direction, and most preferably a winding storage direction, the arms or fingers selectively engage ribs, bosses or other elements formed on the drum wheel, so as to journal the drum wheel and the winding spool in rotational movement. In a non-limiting construction, when the ratchet member is rotated in the second opposite direction contact between the ratcheting members and portions of the drum wheel effects the deformation or deflection of the arms or fingers to biased positions which allow the relative rotation of the ratchet member relative to the drum wheel. In a most preferred construction, the ratchet member limits or restricts inadvertent reverse rotation of the winding spool when the hose is not under tension, to prevent the hose from being unspooled from the winding shaft within the pressure washer housing.

In another non-limiting embodiment, the hose reel assembly may be provided with a winding spool having an axially extending winding shaft about which a flexible hose may be wound or unwound in storage or deployment and which includes a locking and/or tensioning mechanism. The locking mechanism and/or tensioning mechanism is preferably selected to prevent or restrict the rotation of the winding spool about the winding shaft axis under a tensioning or rotational force less than a preselected minimum threshold force.

In one possible construction, the locking mechanism includes a selectively positionable contact member. Preferably, the contact member is movable between an engagement position, where the contact member provides a mechanical or frictional bearing force on the winding spool and/or drum wheel, to restrict spool rotational movement, and a disengaged positioned moved a distance therefrom. Although not essential, the contact member is movably mounted to the pressure washer or air compressor housing or spool support frame, and includes a generally arcuate bearing surface, and optionally a flexible or elastomeric surface configured for bearing contact with a radial edge of the drum wheel.

In another non-limiting construction, the drum wheel may be provided with an annular groove or rim surface which extends radially about the rotational axis of the winding shaft. Although not essential, the rim surface preferably extends inwardly into a sidewall of the drum wheel as part of a recessed side portion of the drum wheel, and includes one or more radially disposed detents. Most preferably the detents are provided with a generally, scalloped, or curtate trochoid shape. In one non-limiting construction, a tensioner having a tensioning slide member is positioned so as to be engageable with one or more selected detent as the drum wheel and winding spool are moved in rotationary movement. Other types of tensioners may however also be employed, including without restriction friction pads or resilient plastic or metal bands, fingers, pawls and ratchet mechanisms. Preferably, the tensioning slide member is resiliently moveable from a radial displaced position where the tensioning slide member moves radially inward by at distance selected to permit relative rotational movement of the drum wheel therepast; to a detent engaging position, where the tensioning slide mover is moved radially outward into engagement, and preferably seated contact with a selected detent. In one possible construction, the tensioning slide member is resiliently biased to the detent engaging position by coil springs or other resiliently compressible members. The springs or compressible members provide a biasing force selected to prevent rotation movement of the drum wheel and/or hose storage wheel relative to the tensioner, on the application of rotationary force therebetween less than a preselected minimum tensioning force. Although not essential, most preferably the preselected tensioning force is selected as a manual pulling force and/or manual winding force applied to the drum wheel and/or winding spool.

Accordingly, the present invention may reside in various non-limiting aspects, including:

(i) A hose reel assembly comprising, a winding spool having a longitudinally extending winding shaft elongated along a shaft axis, a spool support rotatably supporting the winding spool for selective journaled rotation about said shaft axis, a rotatable end cover having an inward facing cover surface oriented towards the winding spool and an outer facing cover surface, the inward facing cover surface including a plurality of radially disposed stop surfaces, a clutch or ratcheting assembly interposed between the winding spool and the end cover and comprising, a drum wheel having an inner facing surface and an outer facing surface joined along a radial edge portion extending concentrically about said shaft axis, the outer facing wheel surface optionally including a plurality of bosses disposed radially about the axis, a ratchet member comprising a plurality of resiliently deformable engagement arms, each of the engagement arms extending from a first end spaced towards the shaft axis to a second end spaced radially outwardly therefrom, and including an engagement member spaced towards said second end, the engagement members being configured whereby rotation of the end cover in a first direction effects movement of the engagement member into an engaging position in bearing contact with a selected boss to effect rotational movement of the drum wheel in rotation about the axis, and rotation of the end cover in a second opposite direction results in or effects the resilient displacement of engagement members from the engaging position to a displaced position whereby the end cover is moved rotationally relative to the drum wheel.

(ii) A reel assembly, and preferably a pressure washer hose reel assembly, comprising, a winding spool having a winding shaft rotatable about a longitudinal extending axis, a spool support rotatably supporting the winding spool for selective rotation about said axis, a flexible hose configured for winding and unwinding about said winding shaft with the selective rotation of said winding spool, an end cover mounted for rotational movement about said axis, the end cover having inward and outer cover surfaces, the inward cover surface being oriented towards the winding spool and including a plurality of stop surfaces spaced radially about said axis, the stop surfaces preferably extending in an orientation transverse to a rotational path of movement of said end cover, a clutch or ratcheting assembly spaced inwardly from said end cover comprising, a drum wheel secured to said winding shaft, the drum wheel having an inner facing surface and an outer facing surface joined along a radial edge portion extending concentrically said axis, the outer facing optionally surface including a plurality of bosses or detents disposed radially about the axis, each said boss including an abutment surface, a ratchet member interposed between said drum wheel and said end cover, the ratchet member comprising a central hub rotatable about said axis and a plurality of resiliently deformable engagement arms, the engagement arms extending radially from the central hub to a respective distalmost end spaced radially outwardly therefrom and including an engagement member disposed at said distalmost end, the engagement members being configured whereby on rotation of the end cover in a first direction, contact between the selected stop surface and a selected engagement member moves the selected engagement member into bearing contact with the abutment surface of one said boss to effect translational rotational movement of the drum wheel about the axis, and on rotation of the end cover in a second opposite direction, contact between the inward cover surface and the selected engagement member effects the resilient displacement of the selected engagement member to a radially inwardly displaced position selected to permit rotational movement of the end covers relative to the drum wheel.

(iii) The assembly according to any of the preceding or hereafter described aspects, further including a brake assembly comprising, a contact member preferably coupled to said spool support, the contact member being selectively positionable relative to said drum wheel between a locking position, where the contact member is moved into engagement with a surface portion of the drum wheel to restrict rotational movement of the drum wheel about the axis against a selected rotational force, and an unlocked position, where the application of the selected rotational force effects rotational movement of the drum wheel about the axis, and an actuator for selectively positioning the contact member in the locking and unlocked position.

(iv) The assembly according to any of the preceding or hereafter described aspects, wherein the contact member comprises a plastic or elastomeric member having a generally arcuate surface, the arcuate surface characterized by a curvature substantially corresponding to a radial curvature of said radial edge portion.

(v) The assembly according to any of the preceding or hereafter described aspects, further comprising a tensioner for maintaining a tension against winding spool rotational movement.

(vi) The assembly according to any of the preceding or hereafter described aspects, wherein the inner facing surface of the drum wheel includes an annularly extending rim, the rim characterized by a plurality of detents disposed radially about said axis, and preferably wherein said detents include at least one generally scalloped or curtate trochoid shaped recess, and the tensioner comprises, a slide member having an engagement surface configured for mated engagement with at least one of said detents, the slide member being reciprocally movable radially between a seated position, wherein said engagement surface is moved radially outwardly into substantially juxtaposed contact with a selected one of said detents, and a displaced position where the slide member is moved radially inwardly from the seated position by a distance selected to permit repositioning of the slide member into a next radially adjacent detents, and a biasing assembly for resiliently biasing the slide member to the seated position.

(vii) The assembly according to any of the preceding or hereafter described aspects, wherein the biasing assembly comprises at least one resiliently compressible spring, the at least one spring providing a spring force selected to prevent movement of the slide member from the seated position to the displaced position on the application of a rotational force on the drum wheel less than a minimum preselected force.

(viii) The assembly according to any of the preceding or hereafter described aspects, wherein the biasing assembly comprises two said resiliently compressible springs, the springs being spaced in a generally radial direction and configured whereby the application of a rotational force on the drum wheel equal or exceeding the minimum preselected force effects a pivotal and sliding movement of said slide member relative to the drum wheel.

(ix) The assembly according to any of the preceding or hereafter described aspects, wherein end cover includes a winding handle, boss or grip on the outer facing cover surface, and the selected rotational force comprises a manual rotational force applied to the winding handle or grip.

(x) The assembly according to any of the preceding or hereafter described aspects, wherein each of the winding spool, spool support, end cover, ratchet member and drum wheel are formed from plastic, and preferably substantially entirely from plastic.

(xi) The assembly according to any of the preceding or hereafter described aspects, further comprising a flexible hose configured for coiled winding and unwinding about the winding spool, wherein the application of the minimum preselected force comprises a manual tension force on the hose.

(xii) The assembly according to any of the preceding or hereafter described aspects, wherein the tensioner comprises either a stand-alone tensioner or is provided as a part of the brake assembly.

(xiii) The assembly according to any of the preceding or hereafter described aspects, wherein said annularly extending rim extends as an internally recessed rim concentric about said axis.

(xiv) The assembly according to any of the preceding or hereafter described aspects, wherein the surface portion comprises part of the radial edge portion.

(xv) The assembly according to any of the preceding or hereafter described aspects, wherein each said boss includes an abutment surface, the abutment surface oriented generally normal to a path of engagement member movement and positioned to be engageable by a selected said engagement member when moved by rotation of the end cover in the first direction.

(xvi) The assembly according to any of the preceding or hereafter described aspects, wherein the ratchet member comprises a central hub, each of the central hub and engagement arms being integrally formed, the central hub and drum wheel being disposed for rotatable movement about said axis interposed between said end cover and said drum wheel.

(xvii) The assembly according to any of the preceding or hereafter described aspects, further including a spool brake comprising, a contact member selectively movable relative to said drum wheel between a locking position, where the contact member is moved into engaging contact with a surface portion of the winding spool or drum wheel to restrict rotational movement of the drum wheel about the axis against a selected rotational force, and an unlocked position, where the contact member is moved away from engaging contact with the surface portion such that the application of the selected rotational force effects rotational movement of the drum wheel about the axis, and an actuator for selectively positioning the contact member in the locking and unlocked positions.

(xviii) The assembly according to any of the preceding or hereafter described aspects, further comprising a winding handle or grip mounted on the outer cover surface, the selected rotational force comprises a manual rotational force applied to the winding handle or grip.

(xix) The assembly according to any of the preceding or hereafter described aspects, wherein the surface portion of the drum wheel comprises the radial edge portion, the contact member comprises a generally arcuate bearing surface by a wheel bearing surface having curvature substantially corresponding to a radial curvature of said radial edge portion.

(xx) The assembly according to any of the preceding or hereafter described aspects, further comprising a tensioner for maintaining a tension against winding spool rotational movement.

(xxi) The assembly according to any of the preceding or hereafter described aspects, wherein the inner facing surface comprises an annular rim generally concentric with said axis, said rim comprising a plurality of radially disposed toothed, generally scalloped or curtate trochoid shaped recesses, the hose reel assembly further comprising a spool tensioner comprising, at least one of a resiliently deformable flange or tab positioned for selective engagement with a portion of the drum wheel, and preferably said annular rim, and a slide member having an engagement surface configured for mated engagement with at least one of said shaped recesses, the slide member being reciprocally movable between a seated position, wherein said engagement surface is moved radially outwardly into substantially juxtaposed contact with a selected said shaped recess, and a displaced position where the slide member is moved radially inwardly a distance selected to permit movement of the slide member into a next radially adjacent shaped recess, and biasing assembly for resiliently biasing the slide member from the displaced position towards the seated position.

(xxii) The assembly according to any of the preceding or hereafter described aspects, wherein the biasing assembly comprises at least one resiliently compressible spring providing a spring force selected to prevent movement of the slide member from the seated position to the displaced position on the application of a rotational force on the drum wheel less than a minimum preselected force.

(xxiii) The assembly according to any of the preceding or hereafter described aspects, wherein biasing assembly comprises at least one, and preferably a pair of generally radially spaced resiliently compressible springs, the springs selected whereby bearing contact between the rim and slide member on the application of a rotational force on the drum wheel equal or exceeding the minimum preselected force effects a pivotal and/or sliding movement of said slide member relative to the drum wheel from the seated position to the displaced position, and wherein the application of minimum preselected force comprises a manual tensioning force on the flexible hose.

(xxiv) The assembly according to any of the preceding or hereafter described aspects, wherein the slide member further comprises at least one, and preferably a pair of resiliently deformable positioning arms, the positioning arms configured for resiliently orienting the engagement surface into radial alignment with at least one said shaped recess.

(xxv) The assembly according to any of the preceding or hereafter described aspects, wherein the slide member is reciprocally movable in an annual recess or groove formed in said inner facing surface.

### BRIEF DESCRIPTION OF THE DRAWINGS

Reference may now be had to the following detailed description taken together with the accompanying drawings in which:

FIG. 1 shows a perspective view of a portable high pressure spray washer incorporating a hose reel assembly in accordance with a preferred embodiment of the invention;

FIG. 2 shows an exploded view of the hose reel assembly used in the pressure washer assembly shown in FIG. 1;

FIG. 3 shows a partial schematical view of the hose reel assembly used in the pressure washer shown in FIG. 1 with the end cover removed;

FIG. 4 shows schematically, a perspective view of the drum wheel, ratchet member and brake assembly used in the hose reel assembly shown in FIG. 2;

FIG. 5 shows an exploded view of the drum wheel, ratchet member and brake assembly shown in FIG. 4;

FIG. 6 illustrates a perspective view of the outer facing surface of the wheel drum used in the hose reel assembly shown in FIG. 4;

FIG. 7 illustrates perspective view of the inner facing surface of the wheel drum used in the hose reel assembly shown in FIG. 4;

FIG. 8 shows a partial exploded view of the drum wheel, ratchet member and end cover used in the hose reel assembly shown in FIG. 2;

FIG. 9 shows a perspective view of the outer facing cover surface of the wheel assembly end cover shown in FIG. 8;

FIG. 10 illustrates a perspective view of the inward facing cover surface of the reel assembly end cover shown in FIG. 8;

FIG. 11 shows a schematic view of the hose reel assembly shown in FIG. 2, illustrating the engagement of the ratchet member with the end cover and drum wheel to effect hose winding;

FIGS. 12 and 13 show schematically enlarged partial perspective views illustrating the brake assembly and drum wheel shown in FIG. 4;

FIG. 14 shows schematically, a tensioning assembly used with the drum wheels in accordance with a further embodiment of the invention.

### DETAILED DESCRIPTION OF THE PREFERRED EMBODIMENTS

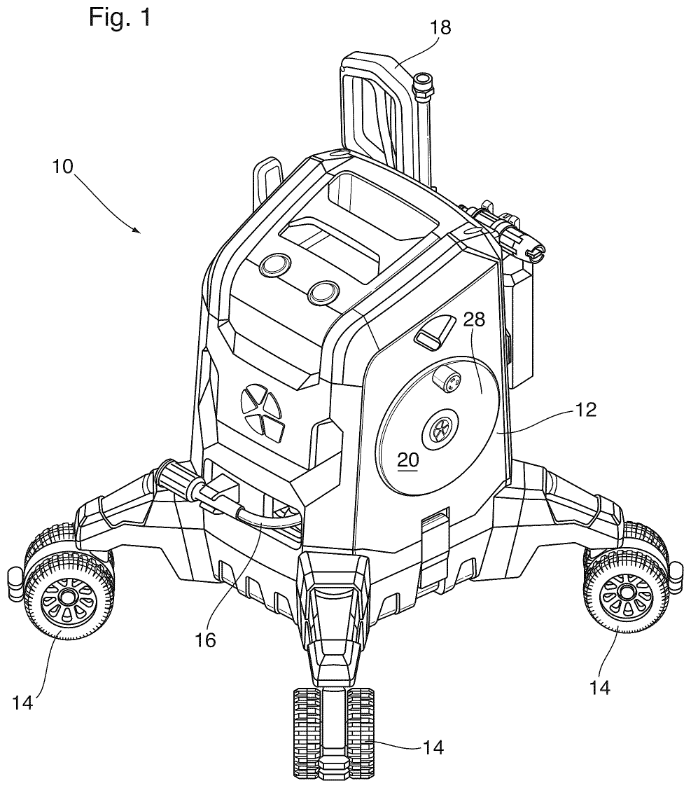

Reference may now be had to FIG. 1 which illustrates a portable high pressure spray washer 10 in accordance with a preferred embodiment of the invention. The pressure spray washer 10 includes a housing 12 which is movably mounted on four caster wheels 14, a flexible spray hose 16 which is adapted for coupling and use with a pressure washer spray wand 18 to selectively output a high pressure water spray, and a hose reel assembly 20. In a conventional manner, the portable pressure washer 10 includes an internal AC/DC output water pump motor (not shown) which is selective operable to provide a pressurized water flow to the hose 16, via a water supply line 21. The hose reel assembly 20 is mounted within the interior of the housing and is used in the deployment and the retraction and storage of the spray hose 16 from and a stored position, wherein the spray hose 16 is substantially contained within the interior of the housing 12, and a partially or fully deployed position, where a length of the spray hose 16 drawn from the housing 12 for used with the spray wand 18.

In operation, the portable pressure washer 10 is typically repositioned during use by the user pulling on a length of spray hose 16 which has been unwound from the housing 12 with a sufficient tension selected to effect rolling movement of the housing 12 via the wheels 14. As will be described, the hose reel assembly 20 is configured to allow such repositioning both when the spray hose 16 is fully deployed from the hose reel assembly 20, as well as when only a partial length of the spray hose 16 has been deployed from a storage configuration housed within the interior of the housing 12.

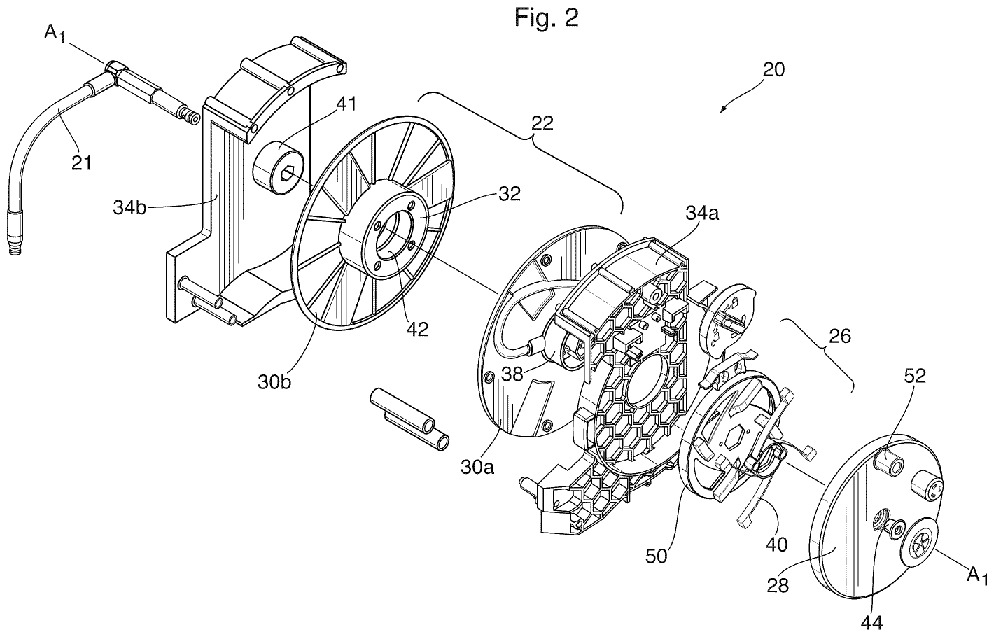

Reference may be had to FIG. 2 which illustrates and exploded view of the hose reel assembly 20 used with the pressure washer 10 of FIG. 1. The hose reel assembly 20 is sized so as to be predominantly contained within the interior of housing 12. The hose reel assembly 20 includes a winding spool 22, a spool support frame 24, a ratcheting or clutch assembly 26 and an end cover 28. In a simplified construction, the clutch assembly 26 includes a ratchet member 40 and a drum wheel 50 and is used to selectively transmit rotational forces between the end cover 28 and winding spool 22. Although not essential, preferably the winding spool 22, spool support frame 24 and clutch assembly ratchet member 40 and drum wheel 50 are formed primarily from plastic, such as Nylon™, ABS or PCV, as resisting corrosion.

The winding spool 22 includes a pair of parallel spaced radial end flanges 30a,30b separated by a centrally axially elongated winding shaft 32. The winding spool 22 is used in the storage and selective deployment of the spray hose 16. The winding spool 22 has an overall size selected to allow its rotatable mounting on the spool support frame 24 within the interior of the housing 20, whilst allowing substantially the entire length of the hose 16 to be stored thereon. The winding spool 22 is positioned in the housing 12 with the winding shaft 32 mounted for coaxial rotation about a winding axis A-A₁. The winding shaft 32 is provided with sufficient axial length and the flanges 30a,30b provided with radial widths, selected to permit substantially the entirety of the spray hose 16 to be coiled in a stored position, wound about the shaft 32 and between the flanges 30a,30b within the housing 12.

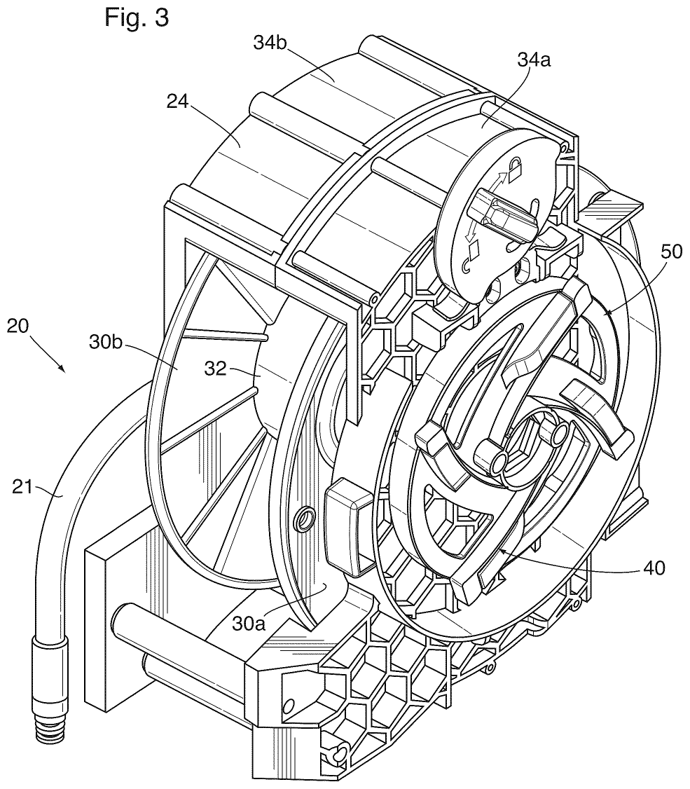

The spool support frame 24 is shown best in FIGS. 2 and 3 as including right and left support members 34a,34b. The support members 34a,34b respectively rotatably support each side of the winding spool 32 with the winding axis A-A₁, in a substantially horizontal orientation, and preferably with the winding shaft 32 positioned generally orthogonally to the direction of deployment of the spray hose 16 as it is drawn or unwound from the housing 12. Although not essential, the right and left support members 34a,34b of the spool support frame 24 are preferably provided with a suitable bearing or rotary support selected to allow substantially unhindered rotation of the winding spool 22 about the axis A₁-A₁. In the preferred embodiment shown, the support member 34a is provided with a central aperture 36 adapted to receive a projecting end shaft 38 of the end flange 30a therein. The left support member 34b includes an axially projecting cylindrical boss 41 sized and positioned for placement within a complimentary bore 40 formed in the end flange 30b. It is to be appreciated that other constructions, including bushings, bearing and or flanges used to rotatably mount the winding spool 22 with the winding shaft 32 in rotational movement in about the axis A-A₁ may also be used.

As will be described, the clutch assembly 26 is configured to allow rotational movement of the winding spool 22 about the axis A₁-A₁ in a first unwinding direction on a user's application of a tensioning force on the spray hose 16 stored thereon; or in a second opposite winding direction on the application of a winding force applied to the end cover 28.

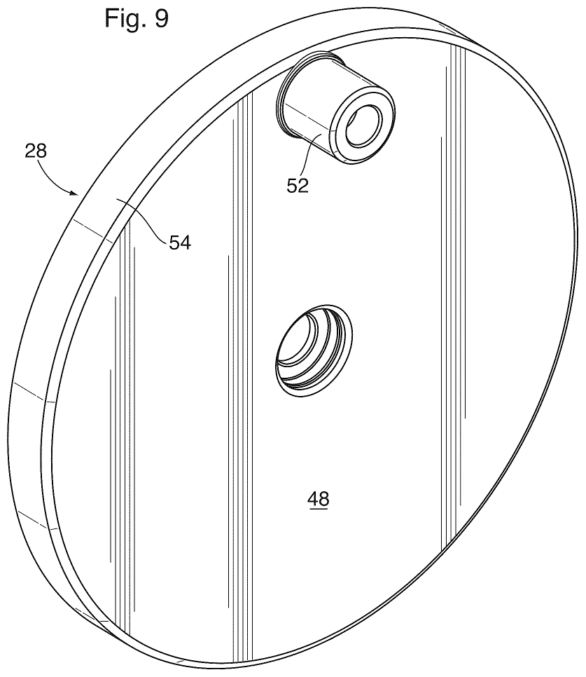

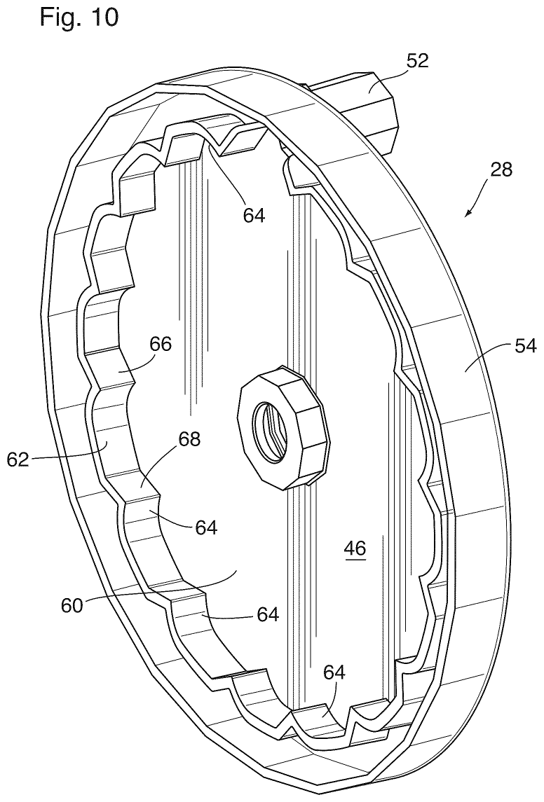

The hose reel assembly 20 is assembled with the end cover 28 mounted for selective rotary movement about axis A-A₁ relative to the winding spool 22 the side of the housing 12 by way of a bearing 44. The end cover 28 is shown best in FIGS. 9 and 10 as generally circular in shape, having inward and outward facing cover side surfaces 46,48. Although not essential, a winding handle 52 is preferably rotatably mounted on the outward facing side surface 48 at a location spaced towards the cover radial edge 58. The handle 52 is used to effect rotation of the end cover 28 and the winding of the spray hose 16 about the winding spool 22 in a storage or coiling direction 100, as the hose 16 is retracted and coiled about the winding shaft 32 in the stored configuration.

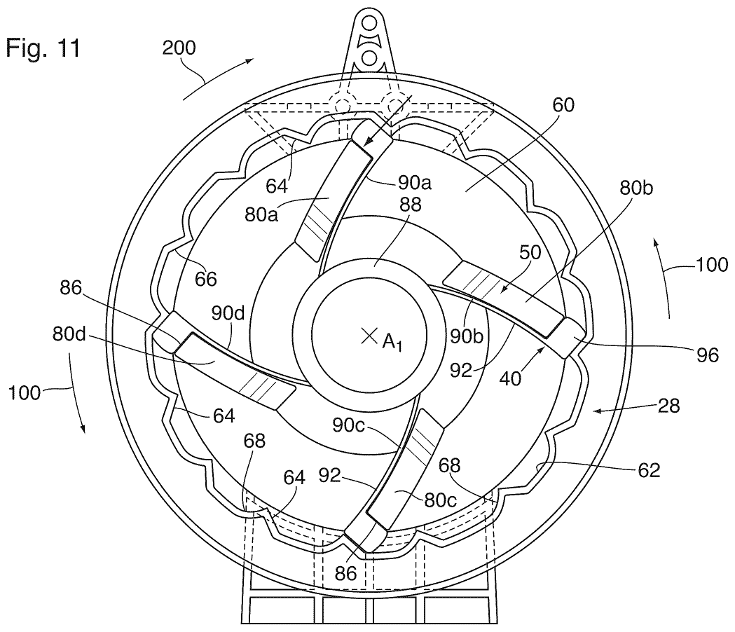

In the hose reel assembly 20, the inward facing surface 46 is oriented proximate-most towards the winding spool 22 so as to selectively engage with the ratchet member 40. As shown best in FIG. 10, the inward surface 46 incorporates a recessed sidewall portion 60 of reduced lateral thickness, and which extends generally radially about the axis A-A₁ from an inner axially central portion of the end cover 28 to a radially spaced lip 62. FIGS. 10 and 11 show best the lip 62 as characterized by a series of radially spaced stop surfaces 64. As will be described, the stop surfaces 64 cooperate with the clutch assembly 26 to translate and effect rotational movement of the end cover 28 to the winding spool 22 in the winding direction 100 only.

The stop surfaces 64 project radially inwardly and include radially spaced generally planar lead bearing surfaces 66 and a curved arcuately extending trailing surface 68. The lead bearing surfaces 66 extend as planar surfaces which are oriented generally tangential to the path of rotational movement 100. The bearing surfaces 66 are positioned so as to be engaged by the ratchet member 40 as the end cover 28 is rotated about the axis A-A₁ in the direction of arrow 100, when retracting the spray hose 16. The trailing surfaces 68 are provided with a curved or generally arcuate shape, and act as camming surfaces for the ratchet member 40 when the end cover 28 is rotated about the axis A-A₁ in a reverse direction 200 counter to the winding direction 100.

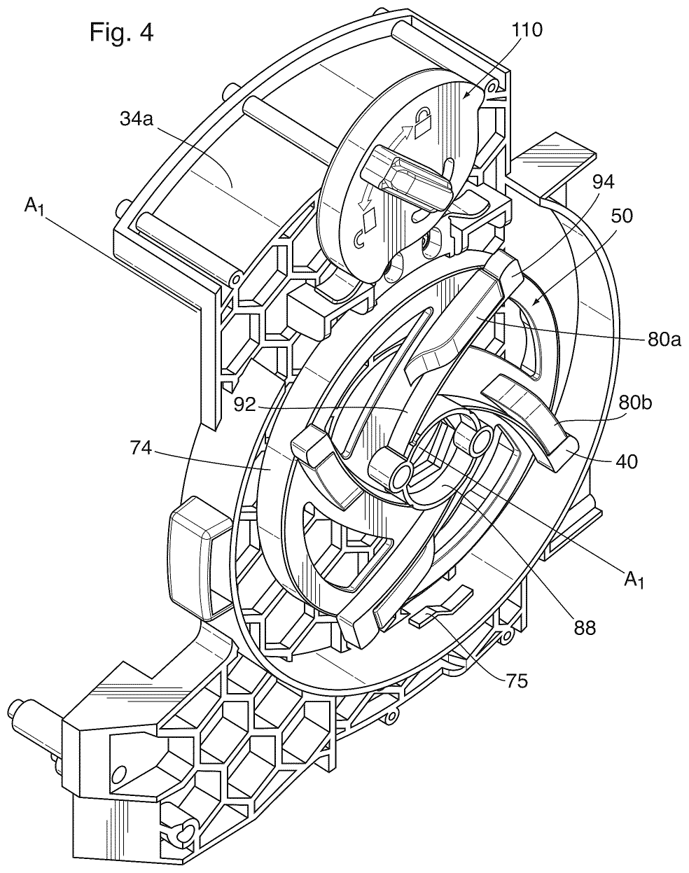

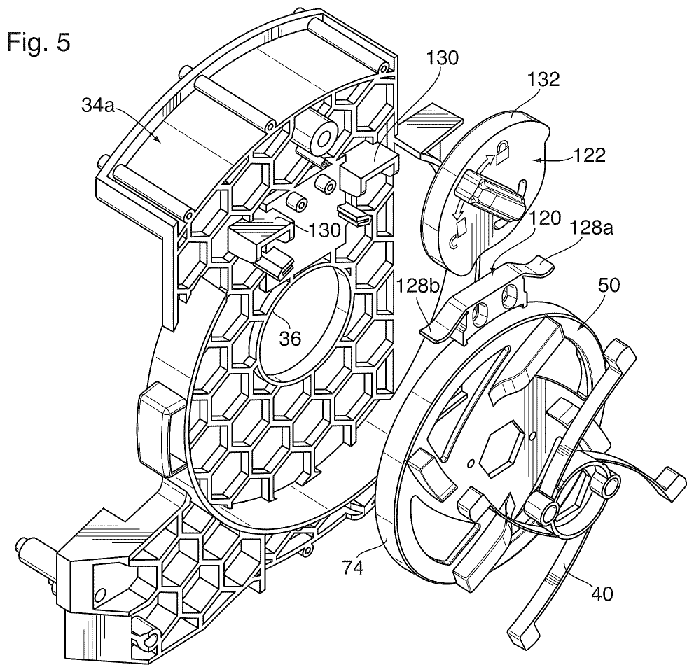

FIGS. 4 to 8 show best the mounting of the clutch assembly 26, ratchet member 40 and drum wheel 50. The drum wheel 50 is fixedly secured to the end of the winding spool 22 for rotation therewith. The ratchet member 40 is positioned interposed between the end cover 28 and drum wheel 50. The ratchet member 40 preferably has an overall dimension selected to allow its substantially nested positioning partially within the recessed sidewall portion 60, so as to be rotatable about the axis A₁-A₁ with the drum wheel 50 and independently from the end cover 28.

Although not essential, the drum wheel 50 is of a generally circular configuration, and is fixed to a portion of the winding shaft 32 which extends through the aperture 36 on an outward facing side of the support member 34a, for coaxial rotation about the axis A-A₁. In a simplified construction, the drum wheel 50 is secured to an axial end of the winding shaft 32 by suitable mechanical fasteners such as screws, clips or the like.

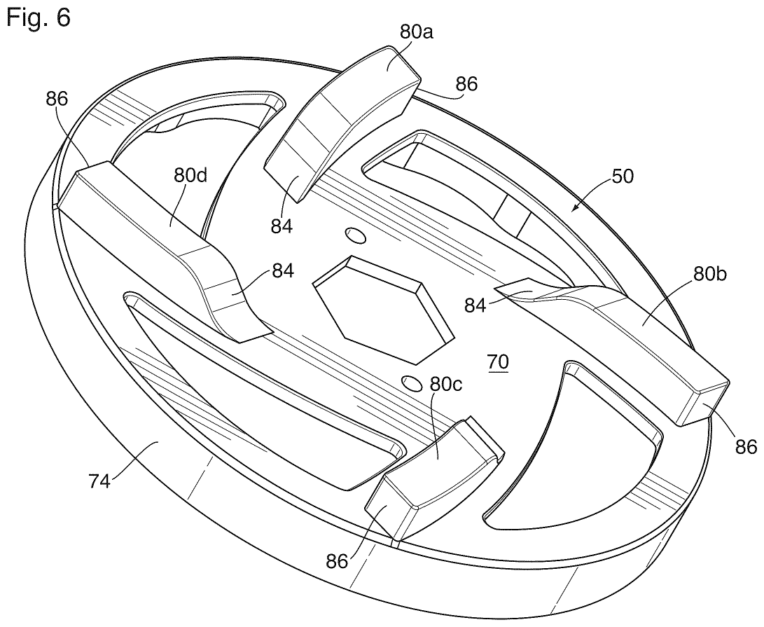

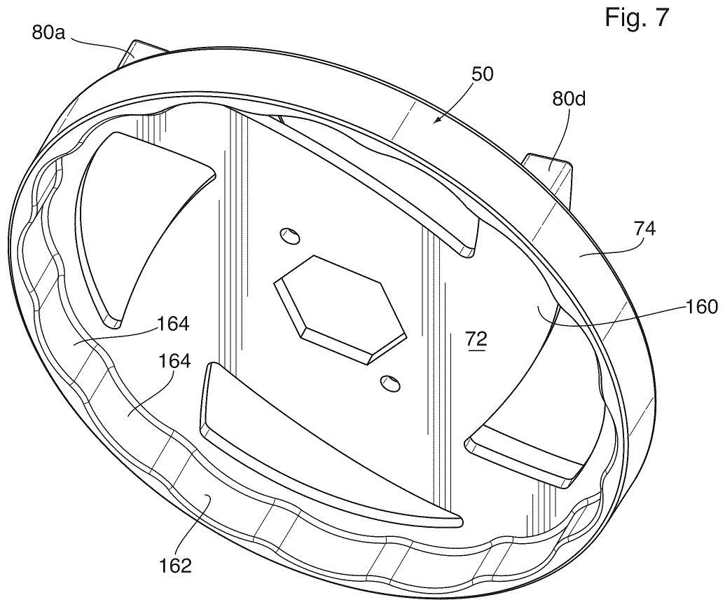

The drum wheel 50 is shown best in FIGS. 6 and 7 as including an outward side surface 70 and an inward side surface 72 which are joined along a radial edge 74 which extends concentrically about the axis A₁-A₁. The outward side surface 70 is shown in FIG. 6 as including four radially spaced raised bosses 80a,80b,80c,80d. Greater or fewer numbers of bosses 80 may however by used. Each of the bosses 80a-80d project laterally outwardly from a remainder of the side surface 70 and tangentially relative to the axis A-A₁ from a radially inward sloped surface 84, to a respective radially outermost abutment surface 86. M ost preferably, the bosses 80a-80d extend laterally so as to be substantially received at least partially within the recessed sidewall portion 60 in a complimentary fit manner with the ratchet member 40. The abutment surfaces 80 are preferably provided as generally planar surfaces which extend in the direction of axis A-A₁, and are oriented in respective planes generally transverse to the rotation direction 100. As will be described, the sloped surfaces 84 are configured as camming surfaces to assist in the deflection and lateral displacement of ratchet member arms 90 when the end cover 28 moves in rotational direction 200, depending on rotational forces applied.

The ratchet member 40 is preferably formed entirely of resilient plastic such as Nylon™, polyethylene or polypropylene. As shown best in FIGS. 4 and 11, the ratchet member 40 is positioned between the inward surface 46 of the end cover 28 and the outward side surface 70 of the drum wheel 50, and most preferably substantially nested within the recessed sidewall portion 60. The ratchet member 40 is mounted so as to be rotatable about the axis A-A₁ with the winding spool 22 and independently from the end cover 20.

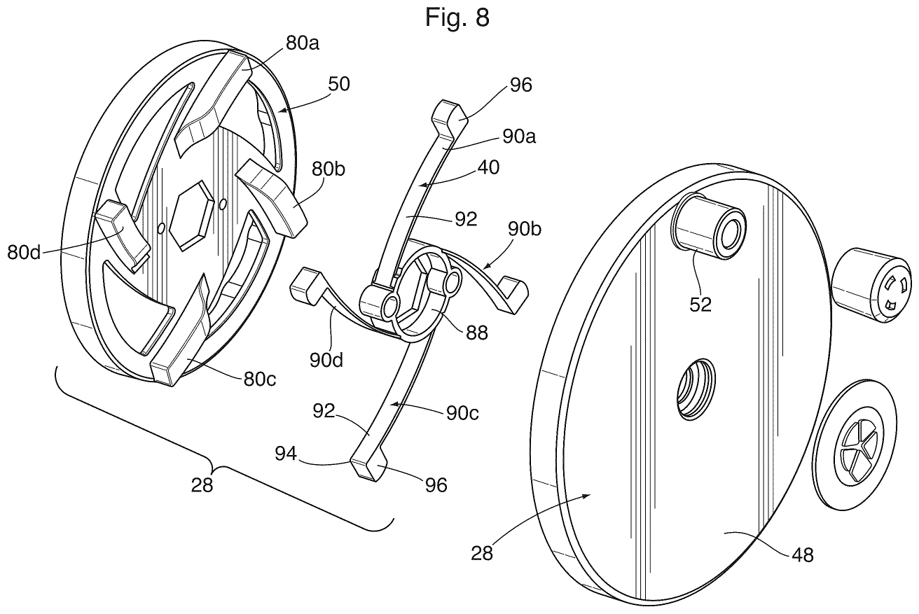

The ratchet member 40 is shown best in FIG. 8 as including a central hub 88 and four radial arms 90a,90b,90c,90d. The hub 88 may be rotatably mounted on a flanged bearing selected to permit rotation of the ratchet member relative to the end cover 28 and drum wheel 50. Each arm 90a-90b includes resiliently deformable finger 92 extending radially outwardly from the hub 88 to a respectively distalmost end 94. FIG. 8 shows an enlarged engagement member 96 as integrally formed at the distalmost end 94 of each finger 92. In a simplified construction, the engagement members 96 are each provided as generally rectangular member, however other shapes and configurations may also be used.

As shown in FIGS. 4 and 11, the radial lengths of the fingers 92 and associated engagement members 94 are configured whereby rotation of the end cover 28 in the winding direction 100, effects contact between the end cover stop surfaces 64 and an associated engage member 94. Such engagement rotationally moves the ratchet member 40 relative to the drum wheel 50 until the associated engagement members 94 are rotated and moved against a boss abutment surface 86. The continued rotation movement of the end cover 28 in the winding rotation direction 100, thus transmits the rotational winding forces of the end cover 28 to the drum wheel 50, to journal the winding spool 22 in rotational movement about the axis A-A₁ therewith. In this manner, continued rotation of the end cover 28 in the winding direction 100, may be used to effect the retraction and coiling of the spray hose 16 about the winding shaft 32, and into a coiled stored position, housed within the pressure washer housing 12.

To deploy the pressure washer hose 16, the hose 16 is grasped by a user and drawn outwardly from the housing 12. As the hose 16 is pulled from the housing, the winding spool 22, drum wheel 50 and ratchet member 40 rotate about the axis A-A₁ in the reverse rotational direction 200. Any reverse rotational movement 200 of the ratchet member 40 relative to the end cover 28, results in contact between the trailing surfaces 68 of the lip 62 moving against the engagement members 90, and results in the deformation and radially inward deflection of the fingers 92.

Similarly, if the end cover 38 is rotated in the reverse direction 200, the end cover 28 moves rotationally relative to the ratchet member 40, bringing the curved trailing surfaces 68 in to contact with an associated engagement member 96. The curvature of the trailing surfaces 68 results in the radial deformation of the ratchet fingers 92, and the inward radial displacement of the engagement members 96, allowing the end cover 28 to rotate independently from the drum wheel 80.

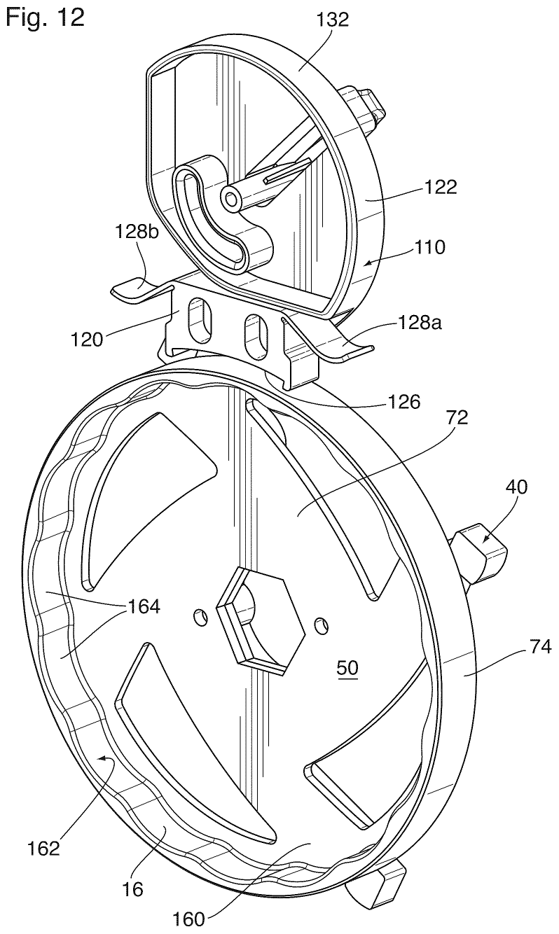

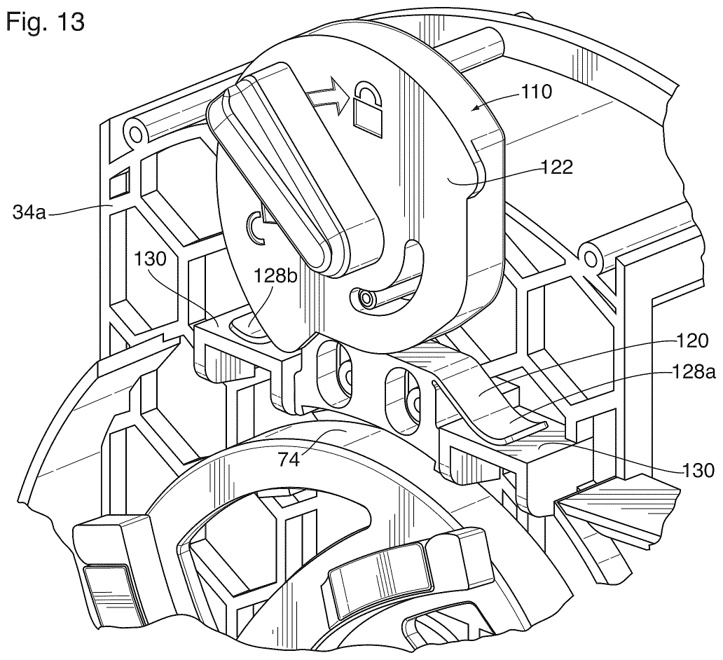

FIGS. 4, 12, 13 show best a brake assembly 110 as being mounted to the support member 34a, and which is operable to lock the winding spool 22 against further rotational movement and limited the further deployment or retraction of spray hose 16 relative to the housing 12. The brake assembly 110 includes a radially displaceable friction block 120 which is mounted so as to be selectively engageable with the radial edge 74 of the drum wheel 50, and camming pawl 122. As shown in FIG. 12, the friction block 120 is provided with an arcuate contact surface 126 which has a radial curvature substantially corresponding to a curvature of the radial edge 74. Optionally, the contact surface 126 may be provided with or formed from rubber or another elastomeric material, to provide enhanced frictional contact when the friction block 120 is engaged.

The friction block 120 is resiliently moveable between an unlocked position, where the contact surface 126 is radially spaced from the radial edge 74, and an engaged position where the contact surface 126 is moved into bearing contact against the radial edge 74, so as to prevent or limit rotation of the drum wheel 50 and the attached winding spool 22 about the axis A₁-A₁.

In one non-limiting construction, the friction block 120 may be provided with a pair of integrally formed spring arms 128a,128b. The spring arms 128a,128b are configured for engagement against abutment surfaces 130 formed in the support member 34a, to resiliently bias the friction block 120 to the unlocked position.

The camming pawl 122 is adapted for rotational movement relative to the friction block 120 to selectively move a pawl camming surface 132 against the friction block 120 to effect its repositioning between the unlocked and bearing positions. The brake assembly 110 may thus advantageously be used to lock the winding spool 22 in a fixed orientation, when for example, the spray hose 16 has been only partially deployed from the housing 12. The brake assembly 110 further allows a partial length of the hose 16 to be deployed and the winding spool 22 thereafter locked in place, allowing the user to effect the repositioning of the spray washer 10 by pulling on a partially deployed hose length, allowing greater control.

In one possible embodiment, the brake assembly 110 may be configured to further act as a tensioner, to maintain a minimum degree of tension or drag on rotational movement of the drum wheel 50. In such a configuration, the friction block 120 may be mounted so as to maintain at least a minimum selected degree of bearing contact with the radial edge 74, even when moved fully to the unlocked position.

In a most preferred construction, the inward side surface 72 of the drum wheel 50 is provided with a recessed sidewall portion 160 of reduced lateral thickness. The recess sidewall portion 160 extends radially about the axis A-A₁ to a radially outer annular rim 162. FIG. 7 shows best the outer rim 162 as being formed with a series of radially spaced curtate trochoid shaped recesses 164.

In other possible constructions a separate tensioner may be provided to limit free rotation of the drum wheel 50 and winding spool 22 about the axis A-A₁. In a most simplified construction, the tensioner may comprise a resiliently deformable metal or plastic finger or tab 75. The tab 75 is mounted to the support member 34a in a position with an end portion in bearing contact with the drum wheel 50 and preferably side surface 72, and most preferably the rim 162. In such a configuration, frictional contact between the deformable tab 75 and drum wheel 50 is selected to limit winding spool 22 rotation under rotational forces less than a predetermined threshold force.

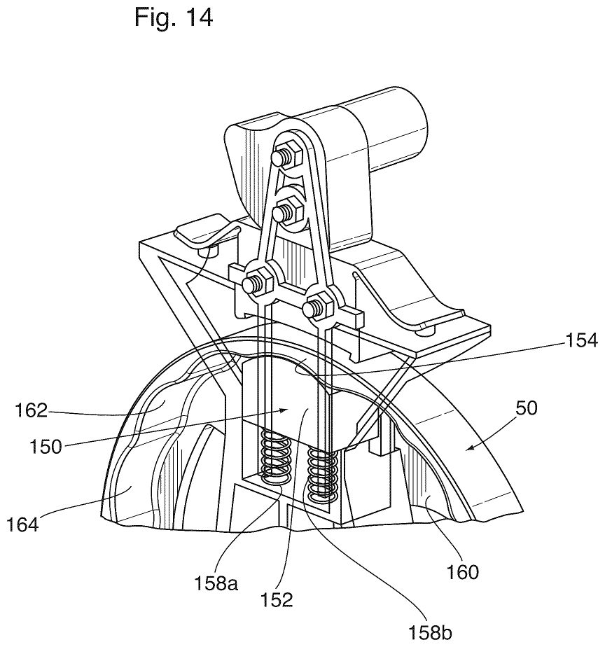

FIG. 14 shows best the tensioner 150 used to engage the drive wheel 50 in accordance with another embodiment. Although not essential, the tensioner 150 advantageous limits the free rotation of the drum wheel 50 and winding spool 22 about the axis A-A₁, and assists in ensuring that a winding tension is maintained on the spray hose 16 as it is both deployed and retracted into the washer housing 12.

The tensioner 150 is mounted to the support member 34a and sized and located for mated placement substantially within the recessed sidewall portion 160. The tensioner 150 includes a slide member 152 having a radially outer most engagement surface 154. The engagement surface 154 has a geometry selected for mated juxtaposed contact within each of the rim recesses 164.

The slide member 152 is moveably mounted on a spring support 146 which includes a pair of parallel spaced compressible helical springs 158a,158b. The slide member 152 is resiliently biased by the compressible springs 158a, 158b to a radially outward spaced position. The springs 158a,158b are selected whereby the application of a predetermined rotational force in the direction of either arrow 100 or arrow 200 by either the end cover 28 or winding spool 22, effects movement of the drum wheel 50 relative to the tensioner 150. The application of rotational forces on the drum wheel 50, equal to or greeted a minimum preselected force, effects the pivotal and radial inward sliding movement of the slide member 152 relative to the rim 162, and the repositioning of the engagement surface 154 into a next radially adjacent recess 164. The movement of the slide member 152 and repositioning of the engagement surface 154 into radially adjacent recesses 164, may therefore advantageously provide a tensioning or friction force against winding spool 22 rotation.

Although the detailed description describes and illustrates various preferred embodiments in accordance with the best mode contemplated, the invention is not so limited. Many modifications and variations will now occur to those skilled in the art.

What is claimed is:

1. A hose reel assembly, comprising:
a winding spool having a longitudinally extending winding shaft elongated along a shaft axis;
a spool support rotatably supporting the winding spool for selective journaled rotation about said shaft axis;
a rotatable end cover having an inward facing cover surface oriented towards the winding spool and an outer facing cover surface, the inward facing cover surface including a plurality of radially disposed stop surfaces; and
a ratcheting assembly interposed between the winding spool and the end cover, and comprising
a drum wheel having an inner facing surface and an outer facing surface joined along a radial edge portion extending concentrically about said shaft axis,
the outer facing wheel surface including a plurality of bosses disposed radially about the axis, and
a ratchet member comprising a plurality of resiliently deformable engagement arms, each of the engagement arms extending from a first end spaced towards the shaft axis to a second end spaced radially outwardly therefrom, and including an engagement member spaced towards said second end, the engagement members being configured whereby rotation of the end cover in a first direction effects movement of the engagement member into an engaging position in bearing contact with a selected boss to effect rotational movement of the drum wheel in rotation about the axis, and rotation of the end cover in a second opposite direction effects the resilient displacement of engagement members from the engaging position to a displaced position whereby the end cover is moved rotationally relative to the drum wheel.

2. The hose reel assembly as recited in claim 1, and further comprising a brake assembly including
a contact member coupled to said spool support, the contact member being selectively positionable relative to said drum wheel between a locking position, where the contact member is moved into engagement with a surface portion of the drum wheel to restrict rotational movement of the drum wheel about the axis against a selected rotational force, and an unlocked position, where the application of the selected rotational force effects rotational movement of the drum wheel about the axis, and
an actuator for selectively positioning the contact member in the locking and unlocked position.

3. The hose reel assembly as recited in claim 2, wherein the contact member comprises a plastic or elastomeric member having a generally arcuate surface, the arcuate surface characterized by a curvature substantially corresponding to a radial curvature of said radial edge portion.

4. The hose reel assembly as recited in claim 2, and further comprising a tensioner for maintaining a tension against winding spool rotational movement.

5. The hose reel assembly as recited in claim 4, wherein the inner facing surface of the drum wheel includes an annularly extending rim, the rim characterized by a plurality of detents disposed radially about said axis, and preferably wherein said detents include at least one generally scalloped or curtate trochoid shaped recess, and
the tensioner comprises
a slide member having an engagement surface configured for mated engagement with at least one of said detents, the slide member being reciprocally movable radially between a seated position, wherein said engagement surface is moved radially outwardly into substantially juxtaposed contact with a selected one of said detents, and a displaced position where the slide member is moved radially inwardly from the seated position by a distance selected to permit repositioning of the slide member into a next radially adjacent detent, and
a biasing assembly for resiliently biasing the slide member to the seated position.

6. The hose reel assembly as recited in claim 5, wherein the biasing assembly comprises at least one resiliently compressible spring, the at least one spring providing a spring force selected to prevent movement of the slide member from the seated position to the displaced position on the application of a rotational force on the drum wheel less than a minimum preselected force.

7. The hose reel assembly as recited in claim 6, wherein the biasing assembly comprises two said resiliently compressible springs, the springs being spaced in a generally radial direction and configured whereby the application of a rotational force on the drum wheel equal or exceeding the minimum preselected force effects a pivotal and sliding movement of said slide member relative to the drum wheel.

8. The hose reel assembly as recited in claim 2, wherein the end cover includes a winding handle, boss or grip on the outer facing cover surface, and the selected rotational force comprises a manual rotational force applied to the winding handle or grip.

9. The hose reel assembly as recited in claim 8, wherein each of the winding spool, spool support, end cover, and ratcheting assembly are formed from plastic.

10. The hose reel assembly as recited in claim 6, and further comprising a flexible hose configured for coiled winding and unwinding about the winding spool, wherein the application of the minimum preselected force comprises a manual tension force on the hose.

11. The hose reel assembly as recited in claim 10, wherein the tensioner comprises a part of the brake assembly.

12. The hose reel assembly as recited in claim 5, wherein said annularly extending rim extends as an internally recessed rim concentric about said axis.

13. The hose reel assembly as recited in claim 2, wherein the surface portion comprises part of the radial edge portion.

14. The hose reel assembly as recited in claim 1, wherein each said boss includes an abutment surface, the abutment surface oriented generally normal to a path of engagement member movement and positioned to be engageable by a selected said engagement member when moved by rotation of the end cover in the first direction.

15. The hose reel assembly as recited in claim 1, wherein the ratchet member comprises a central hub, each of the central hub and engagement arms being integrally formed,
the central hub and drum wheel being disposed for rotatable movement about said axis interposed between said end cover and said drum wheel.

16. A pressure washer hose reel assembly, comprising:
a winding spool having a winding shaft rotatable about a longitudinal extending axis,
a spool support rotatably supporting the winding spool for selective rotation about said axis,
a flexible hose configured for winding and unwinding about said winding shaft with the selective rotation of said winding spool,
an end cover mounted for rotational movement about said axis, the end cover having inward and outer cover surfaces, the inward cover surface being oriented towards the winding spool and including a plurality of stop surfaces spaced radially about said axis, the stop surfaces extending in an orientation transverse to a rotational path of movement of said end cover,
a ratcheting assembly spaced inwardly from said end cover, comprising
a drum wheel secured to said winding shaft, the drum wheel having an inner facing surface and an outer facing surface joined along a radial edge portion extending concentrically said axis, the outer facing surface including a plurality of bosses disposed radially about the axis, each said boss including an abutment surface, and
a ratchet member interposed between said drum wheel and said end cover, the ratchet member comprising a central hub rotatable about said axis and a plurality of resiliently deformable engagement arms, the engagement arms extending radially from the central hub to a respective distalmost end spaced radially outwardly therefrom and including an engagement member disposed at said distalmost end,
the engagement members being configured whereby on rotation of the end cover in a first direction, contact between the selected stop surface and a selected engagement member moves the selected engagement member into bearing contact with the abutment surface of one said boss to effect translational rotational movement of the drum wheel about the axis, and on rotation of the end cover in a second opposite direction, contact between the inward cover surface and the selected engagement member effects the resilient displacement of the selected engagement member to a radially inwardly displaced position selected to permit rotational movement of the end covers relative to the drum wheel.

17. The pressure wash hose reel assembly as recited in claim 16, and further comprising a spool brake, including:
a contact member selectively movable relative to said drum wheel between a locking position, where the contact member is moved into engaging contact with a surface portion of the winding spool or drum wheel to restrict rotational movement of the drum wheel about the axis against a selected rotational force, and an unlocked position, where the contact member is moved away from engaging contact with the surface portion such that the application of the selected rotational force effects rotational movement of the drum wheel about the axis, and
an actuator for selectively positioning the contact member in the locking and unlocked positions.

18. The pressure washer hose reel assembly as recited in claim 17, and further comprising a winding handle or grip mounted on the outer cover surface, the selected rotational force comprises a manual rotational force applied to the winding handle or grip.

19. The pressure washer hose reel assembly as recited in claim 17, wherein the surface portion comprises the radial edge portion of the drum wheel,
the contact member comprises a generally arcuate bearing surface by a wheel bearing surface having curvature substantially corresponding to a radial curvature of said radial edge portion.

20. The pressure washer hose reel assembly as recited in claim 16, and further comprising a tensioner for maintaining a tension against winding spool rotational movement.

21. The pressure washer hose reel assembly as recited in claim 16, wherein the inner facing surface comprises an annular rim generally concentric with said axis, said rim comprising a plurality of radially disposed toothed, generally scalloped or curtate trochoid shaped recesses,
the hose reel assembly further comprising a spool tensioner including
a slide member having an engagement surface configured for mated engagement with at least one of said shaped recesses, the slide member being reciprocally movable between a seated position, wherein said engagement surface is moved radially outwardly into substantially juxtaposed contact with a selected said shaped recess, and a displaced position where the slide member is moved radially inwardly a distance selected to permit movement of the slide member into a next radially adjacent shaped recess, and
a biasing assembly for resiliently biasing the slide member from the displaced position towards the seated position.

22. The pressure washer hose reel assembly as recited in claim 21, wherein the biasing assembly comprises at least one resiliently compressible spring providing a spring force selected to prevent movement of the slide member from the seated position to the displaced position on the application of a rotational force on the drum wheel less than a minimum preselected force.

23. The pressure washer hose reel assembly as recited in claim 22, wherein the biasing assembly comprises a pair of generally radially spaced resiliently compressible springs,
the springs selected whereby bearing contact between the rim and slide member on the application of a rotational force on the drum wheel equal or exceeding the minimum preselected force effects a pivotal and/or sliding movement of said slide member relative to the drum wheel from the seated position to the displaced position, and
wherein the application of minimum preselected force comprises a manual tensioning force on the flexible hose.

24. The pressure washer hose reel assembly as recited in claim 23, wherein the slide member further comprises a pair of resiliently deformable positioning arms, the positioning arms configured for resiliently orienting the engagement surface into radial alignment with at least one said shaped recess.

25. The pressure washer hose reel assembly as recited in claim 16, wherein the slide member is reciprocally movable in an annual groove formed in said inner facing surface.
